(19) United States
(12) Patent Application Publication
(10) Pub. No.: US 2004/0114265 A1
(43) Pub. Date: Jun. 17, 2004

(54) User-selectable automatic secure data file erasure of job after job completion

(75) Inventor: Bruce E. Talbert, Webster, NY (US)

Correspondence Address: Patent Documentation Center, Xerox Corporation, Xerox Square, 20th Floor, 100 Clinton Ave. S., Rochester, NY, 14644, US

(73) Assignee: Xerox Corporation

(21) Appl. No.: 10/320,813

(22) Filed: Dec. 16, 2002

(51) Int. Cl. G11B 15/04; G11B 19/04

(52) U.S. Cl. 360/60

(57) ABSTRACT

A user-selectable and/or configurable system/process that ensures the destruction of data files a user wishes to completely erase from a NVM storage medium, such as a hard drive or removable disk. A system administrator can select secure erasure of every job upon its completion and can select secure erasure of at least one NVM of the marking device in which the system/process is used. Additionally, embodiments provide for user selection of secure job erasure via a UI of the marking device or a UI of driver software of the marking device implemented on a personal computer in communication with the marking device.

### CROSS-REFERENCE TO RELATED APPLICATIONS

This application is related to U.S. Patent Application No. 09/871,877, filed Jun. 4, 2001 by Bunker, et al., entitled SECURE DATA FILE ERASURE (Attorney Docket No. D/A0A32).

### FIELD OF THE INVENTION

The invention relates to secure erasure of data from storage media.

### BACKGROUND AND SUMMARY

Many photocopiers, printers, and other reproduction and printing devices now include non-volatile memory (NVM), such as magnetic and optical storage media and including removable disk systems, hard drives, and other storage media systems allowing the device and/or a user to store a job the device uses or is directed to use the stored job. In high security areas (e.g., military installations), there is often a requirement that all jobs that stored on NVM of a device shall be inaccessible once the job is completed. Additionally, users in lower security area often wish to erase data they would like to keep private or confidential for various reasons.

The currently prevalent method of deleting a file is to delete the pointers and/or directory information that allows the device to locate the data; the document images/data files themselves are still resident in the NVM. This method usually does not meet the requirement that the job data shall be erased from the NVM once the job is complete. Current workarounds include: (1) removal of the NVM from the device and locked up at night, or (2) prohibiting NVM installation in the first place.

Lately, secure erase systems that overwrite the data with patterns of 1s, 0s, or random combinations thereof have come into use to meet erasure requirements. However, government agencies and other customers have different requirements as to how many times one can overwrite the appropriate portions of NVM once a job or task is completed, which can lead to difficulties in product design and implementation.

Embodiments of the invention allow a user or a system administrator (SA) to program a device to overwrite the region of NVM in which the data file associated with a print, scan, fax, copy, or other job resides. In embodiments, the data file is overwritten more than once, such as from 2 to about 50 time, with the exact number of overwrites being determined according to a stored default value or a user-input value. Further, in embodiments, the data file is overwritten with a different pattern on each overwrite according to a stored default value or a user-input value. For example, if a user has just printed something stored on a floppy disk, the user can erase it securely with a sequence of patterns of choice. Instead of trying to settle on a single algorithm (e.g., overwrite 3 times, first time with 1s, the second time with 0s, the third time with a random pattern), this allows overwriting “n” times with a set of patterns that can be downloaded to the device.

Thus, the device, medium, and process of the present invention can have, in various embodiments, three parameters:

1. A set of patterns with which the portion of the hard drive that is to be erased will be overwritten. This could be a table of patterns that will be used to overwrite the disk. In embodiments, the table of patterns can be generated in a manner allowing a customer/SA to preprogram the patterns so that the patterns are in a sequence that satisfies an installation's particular security requirements. In pseudo code, this looks like:

PatternTable (N) [symbol] Pattern1, Pattern2, Pattern3, . . . PatternN;

2. A site settable value that allows the customer/SA to program how many patterns with which to overwrite the portion of the hard drive that should be overwritten. The site settable value can be, for example, between 1 and about N (N is the number of patterns in PatternTable). In various embodiments, for example, NumPatternToUse is this site settable value.

3. A site settable value that allows the customer/SA to program how many times the entire set of patterns should be run. It can have any positive value. In various embodiments, NumberOfTimesToCycle can be this value.

The algorithm then uses, in various embodiments, the patterns and the number of overwrites to overwrite the portion of the disk N times. An example of a routine that can be used in embodiments of the invention employing a value like NumberOfTimesToCycle is the pseudocode expression:

For count [symbol] 1 to NumPatternToUse Do

Overwrite region of storage media that stored the data file with PatternTable(count);

This allows for a flexible, programmable sequence of overwrites that should satisfy any overwrite requirement by any customer. Embodiments using a value like NumberOfTimesToCycle can use a routine such as, for example, that expressed by the pseudocode expression:

For NumberOfOverwriteCycle [symbol] 1 to NumberOfTimesToCycle Do

For count [symbol] 1 to NumPattern To Use Do

Overwrite region of storage media that stored the data file with PatternTable(count);

Embodiments employ a user interface (UI) or client activated erase trigger to automatically place the digital copier or printer into, for example, an Image Disk Erasing Routine, where an Image Disk is a storage media used by the device to store data files including scanned images of documents and/or print job data and the like. An example of such an Erasing Routine is a routine that executes three complete erasures with a check to ensure the data is completely erased; per industry or security approved processes. The Erasing Routine removes or destroys any residual data files including documents, images, and the like, on the Image or ESS Disks. In embodiments, a customer selectable UI/client button with confirmation that the process was completed could activate this routine. During this erasing feature, the system would be offline.

Thus, a feature of embodiments is to provide a user-selectable storage medium security erase system comprising an erase trigger that tells a drive sector analyzer to retrieve data file location information from a CPU and send the location information to a secure storage medium eraser that overwrites the data file according to a predetermined secure erase method, the eraser using a type of overwrite pattern and a number of overwrites determined by an erase pattern determiner according to predetermined criteria and/or user input. The erase trigger can be part of the device UI or part of a print driver UI deployed on a personal computer in communication with the device. The erase trigger can be changed as part of a set-up routine of the device, or can be changed by any user or particular classes of users, depending on the particular needs of the user(s). Additionally, embodiments provide for automatic erasure of every job upon completion. Further, embodiments provide for automatic secure erasure of an entire NVM volume of the device according to a schedule that can be configured by a user, such as a system administrator.

An additional feature of embodiments is to apply a method of securely erasing a data file by a providing an erase trigger, determining a location of the data file on the storage medium, overwriting the data file according to a predetermined secure erase method, and determining at least a number of times to overwrite the data file in response to the erase trigger and according to predetermined criteria.

### BRIEF DESCRIPTION OF THE DRAWINGS

FIG. 1 is a perspective view of a digital printing and/or reproducing device that can use embodiments of the invention.

FIG. 2 is a close-up perspective view of a removable storage media drive of the device shown in FIG. 1.

FIGS. 3A, 3B, and 3C are schematic elevational views of a display panel of the device of FIG. 1 showing a graphical user interface in which a user can select parameters of embodiments of the invention.

FIG. 4 is a schematic of a graphical user interface dialog box of a driver that can be implemented on a personal computer to control the device shown in FIG. 1, the dialog box allowing selection of parameters of embodiments of the invention.

FIG. 5 is a schematic flow diagram of a secure overwrite erasure method according to embodiments.

FIG. 6 is a schematic flow diagram of another secure overwrite erasure method according to embodiments.

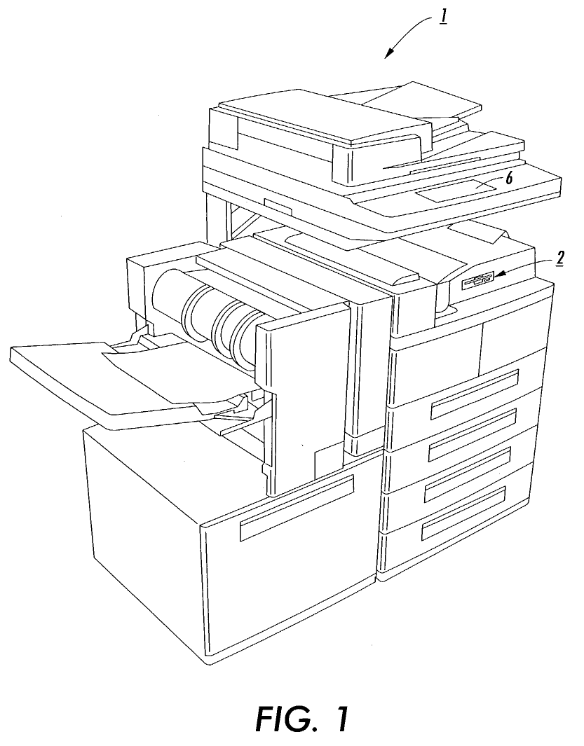

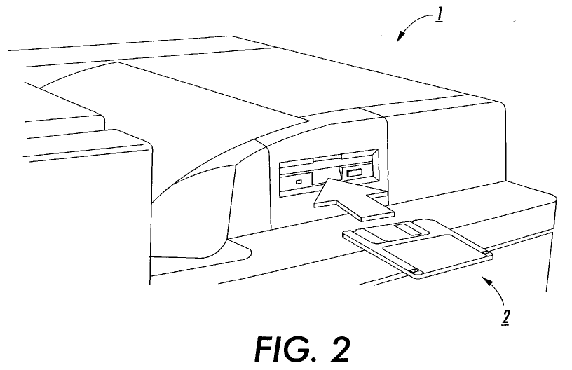

### DETAILED DESCRIPTION OF THE INVENTION

With reference to the accompanying FIGS., various embodiments of the invention include a device 1, such as a scanner, printer, photocopier, or other device, having a non-volatile memory (NVM) 2, such as a magnetic or optical storage medium, to which the device 1 can store data 3 and/or from which the device can read data 3 stored in a data file 4. In embodiments, the device 1 can use the data 3 to produce output, such as paper hard copy of a word processing document or the like.

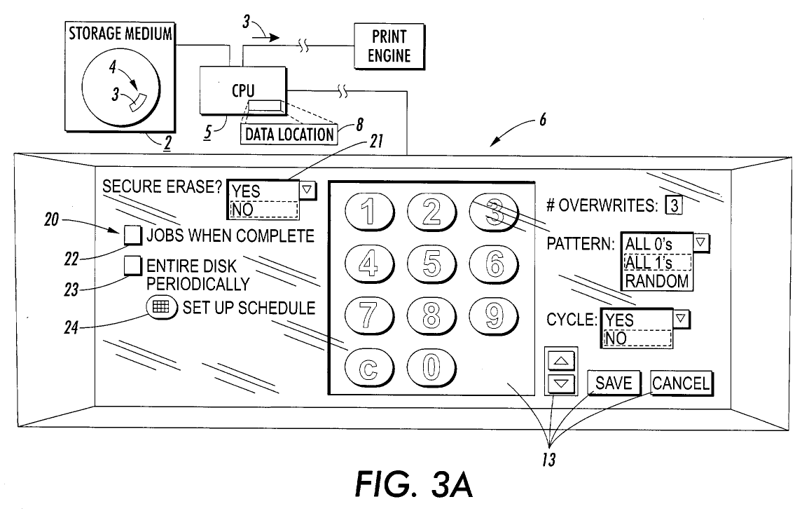

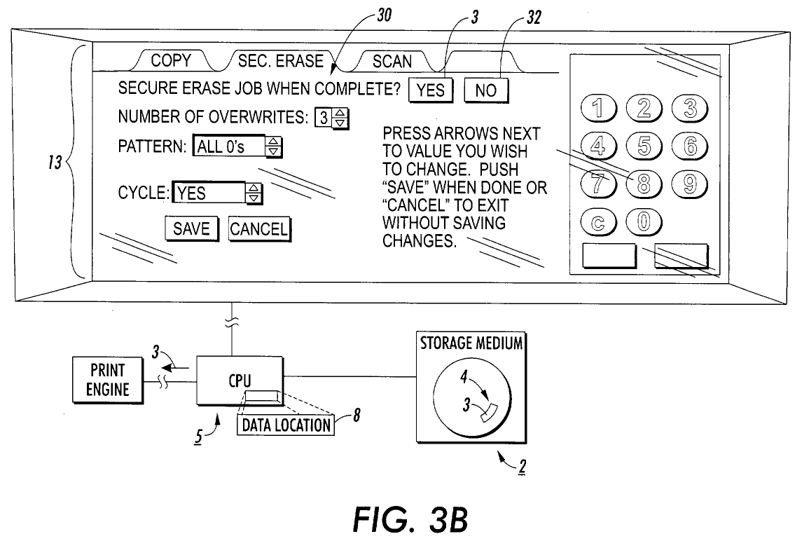

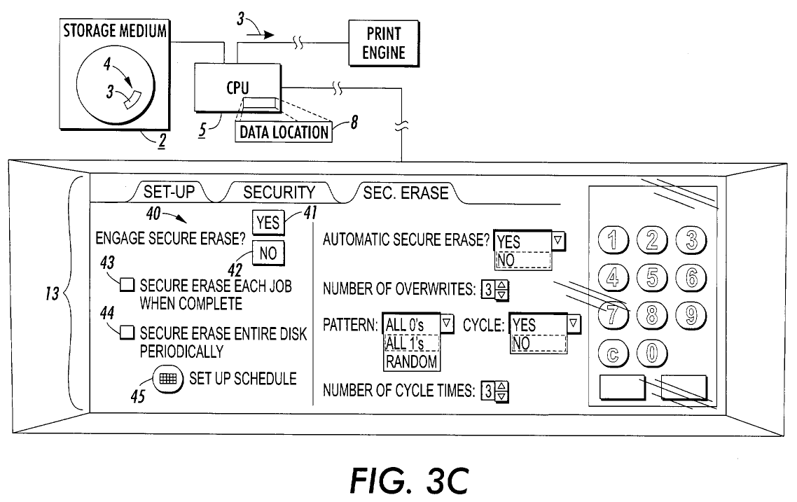

Various embodiments of the invention use a CPU 5 of the device 1 in which elements of the invention reside and that provides and executes various processes of the invention, as seen schematically, for example, in FIGS. 3A-3C. For example, the CPU 5 can provide or respond to an erase trigger 6. The erase trigger 6 in embodiments of the invention can be a physical button on the device, a virtual button on, for example, an LCD of the device, or an instruction sent to the device as part of the data file 4 used to generate output from client software, such as a driver interface 7 on a remote computer. The CPU 5 stores the data file 4 in the NVM 2, which can be a fixed or removable storage medium, and keeps track of the data file 4 so that, when the erase trigger 6 is set, the erasure process can determine a location 8 of the data file on the NVM 2. The erasure process then overwrites the data file 4 according to a predetermined secure erase method; in embodiments of the invention, the secure erase method can include overwriting the data file 4 a particular number of times 9, using a particular pattern 10 to overwrite the data file 4 (such as all 1s, all 0s, etc.), and/or cycling the overwrite pattern on each iteration of the overwrite process 11. Other iteration and pattern variations can also be used.

In particular, referring to FIG. 3A, a user-configurable secure erase configuration UI 20 can be provided in embodiments. This secure erase configuration UI 20 is particularly suited to a set-up portion of the device UI. The configuration UI 20 can include a secure erase indicator 21 with which the user can instruct the device 1 to use secure erase, and which can act as the erase trigger 6. Additional GUI elements can be included, such as an automatic job secure erase element 22, and an automatic scheduled disk secure erase element 23. Further, a schedule set-up element 24 can be included for use when a user indicates that the entire disk should be erased periodically. Alternatively, a period can be assumed by the device 1.

Embodiments can also include an alternate secure erase configuration UI 30, seen schematically in FIG. 3B, that is particularly suited to use by a walk-up user on a per-job basis. The configuration UI 30 can include elements 31, 32 to indicate whether secure erase of the user's job should be employed and that can act as the erase trigger 6. A default value can be used for such indication, depending on the needs of the user.

Embodiments can include another secure erase configuration UI 40, seen schematically in FIG. 3C, that could be used in a set-up portion of a device UI or could be used by a walk-up user. The configuration UI 40 can include elements 41, 42 to indicate whether secure erase should be employed and that can act as the secure erase trigger. Additionally, the configuration UI can include an element 43 to indicate that each job should be secure erased upon completion. Further, the configuration UI 40 can include an element 44 indicating that secure erase should be employed on the entire NVM volume of the device 1 on a periodic basis. If embodiments include a schedule set-up element 45, then a user can configure the periodic secure erasure of the NVM volume of the device 1 when indicated by an element 44.

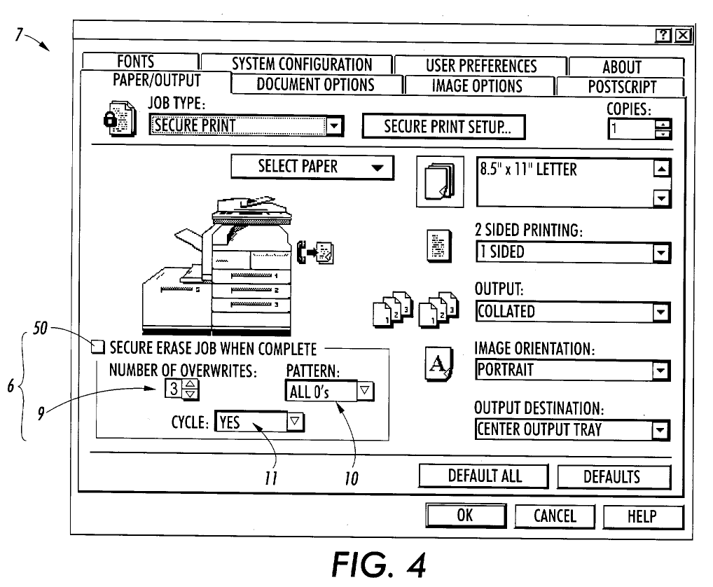

To determine at least a number of times to overwrite the data file 4, the erasure process can check or respond to, for example, the erase trigger 6, which can include this information. Alternatively, in embodiments where the invention is implemented in a photocopier or the like, the user can be prompted to enter the number of times 9 and/or pattern(s) 10 to use to overwrite the data file 4. In embodiments in which the erase trigger 6 is provided from a driver interface 7, such as that shown schematically in FIG. 4, the user can indicate that secure erase of the job should be employed by employing a GUI element 50, such as a check box. Additionally, in embodiments the user can provide parameters of the secure erase routine, such as the number of times 9 and/or pattern(s) 10 to use to overwrite the data file 4 when creating the job in the first place. Other user interfaces could also be employed, such as a web- or markup-language-based interface usable over a network and other interfaces, to provide the erase trigger 6 and the various parameters a user might be allowed to enter.

In embodiments, users can select the various parameters. The CPU 5 can provide one or more graphical user interface (GUI) element(s) 13 in communication with or acting as the erase trigger 6. The CPU 5 can accept the user-selected parameter(s) from the GUI element(s) 13 with which to overwrite the data file. For example, the GUI element can be a virtual button or keypad displayed on a pressure-sensitive display of the device, such as that shown in FIGS. 3A-3C. In embodiments, the GUI element(s) 13 can be part of a driver interface similar to that shown in FIG. 4.

In addition to user-selectable criteria, embodiments of the invention can allow a system administrator (SA) to program the device 1 to overwrite the data file 4 according to predetermined criteria, such as a stored number of overwrites 9 and/or sequence of patterns 10 of choice. Rather than trying to settle on a single algorithm (e.g., overwrite 3 times, first time with 1s, the second time with 0s, the third time with a random pattern) for all customers, this allows selection by the SA during setup or reconfiguration of the device 1. Further, embodiments of the invention can allow the SA to program a timer that will automatically delete all data files after a specified period has elapsed.

Where more than one pattern 10 is available, a set of patterns 12 can be stored in a storage medium 2 in communication with the system. The set of patterns 12 can be stored in a computer memory or another storage medium in, for example, a table, such as a table resembling the pseudocode expression:

PatternTable (N) [symbol] Pattern1, Pattern2, Pattern3, . . . PatternN.

The invention can then use the set of patterns 12, the number of times to overwrite 9, and a pattern selection variable to erase the data file 4 by overwriting. For example, in embodiments of the invention, the user-selected pattern NumPatternToUse to be used and a number of times N to overwrite the data file 4 according to the pseudocode expression:

For count [symbol] 1 to NumPatternToUse Do

Overwrite region of storage media that stored the data file with PatternTable(count);

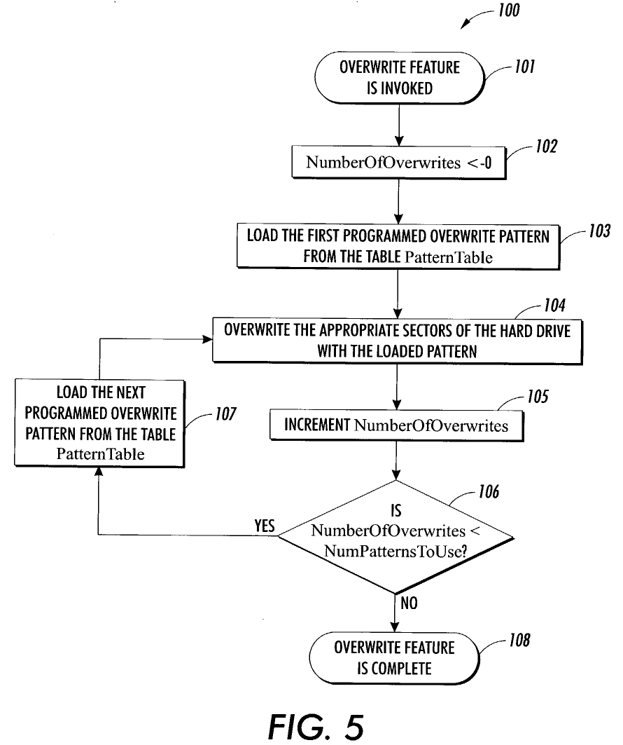

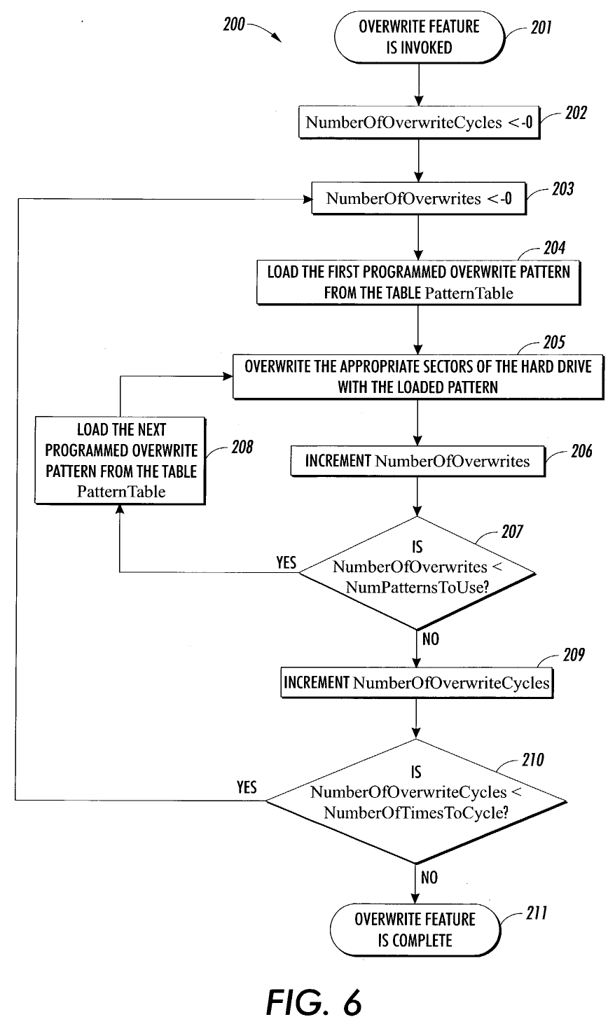

FIGS. 5 and 6 show two flow charts that show how embodiments of the invention might carry out the erasure process. Referring to FIG. 5, an embodiment of the process 11 using predetermined patterns from a pattern table, as well as a predetermined number of patterns to use (expressed by the variable NumPatternsToUse) is shown in flow chart 100. The erase trigger 6 is represented in the beginning block 101 of the flow chart 100 and an initial step is to set the counter NumberOfOverwrites to 0 as shown in block 102. Next, the first overwrite pattern is loaded from the pattern table, as seen in block 103. The data file 4 is overwritten using the loaded pattern as illustrated in block 104, and the NumberOfOverwrites is incremented as seen in block 105. The counter is compared to the number of patterns to use as shown in block 106. If the counter value is less than the number of patterns to use, then the next pattern is loaded as seen in block 107, and the steps shown in blocks 104-107 continue to be executed until the counter value is no longer less than the number of patterns to use, at which point the overwrite is complete, as expressed in block 108.

Referring to FIG. 6, an embodiment of the invention 11 using predetermined patterns from a pattern table, as well as a predetermined number of patterns to use (expressed by the variable NumPatternsToUse) is shown in flow chart 200 with the added feature of a number of overwrite cycles to be completed. The erase trigger 6 is represented in the beginning block 201 of the flow chart 200 and an initial step is to set the counter NumberOfOverwriteCycles to 0 as shown in block 202, then to set the counter NumberOfOverwrites to 0 as shown in block 203. Next, the first overwrite pattern is loaded from the pattern table, as seen in block 204. The data file 4 is overwritten using the loaded pattern as illustrated in block 205, and the NumberOfOverwrites is incremented as seen in block 206. The counter NumberOfOverwrites is compared to the number of patterns to use as shown in block 207. If the counter value is less than the number of patterns to use, then the next pattern is loaded as seen in block 208, and the steps shown in blocks 205-208 continue to be executed until the counter NumberOfOverwrites has a value that is no longer less than the number of patterns to use, at which point the particular overwrite is complete and the counter NumberOfOverwriteCycles incremented, as expressed in block 209. As shown in block 210, the value of the counter NumberOfOverwriteCycles is compared to a predetermined NumberOfTimesToCycle. If this counter value is less than the number of times to cycle, then the counter NumberOfOverwrites is reset, and the steps shown in blocks 203-210 continue to be executed until the counter NumberOfTimesToCycle has a value that is no longer less than the number of times to cycle, at which point the particular overwrite is complete as seen in block 211.

As should be readily apparent to one of ordinary skill in the art, the preprogrammed values of NumberOfOverwrites and NumberOfTimesToCycle, as well as the preselected patterns, of the particular processes shown in FIGS. 5 and 6 could be user selected values entered into the system using apparatus and methods such as those shown in FIGS. 3 and 4, among others.

Thus, in installations where customers wish to ensure data security, such as high security areas like military installations, customers can meet the requirement that all printed/copied jobs stored on hard drive(s) or other storage media of such devices be inaccessible once the job has completed without removing the storage medium. In addition, many customers simply want to ensure the privacy of their information and wish to erase print and/or copy jobs from storage media on which the jobs might be stored. The current conventional method of deleting a file (deleting the pointers to the data) can still be done, but the method according to embodiments of the invention ensures that data files themselves no longer reside on the disk and can not be recovered.

While particular embodiments have been described, alternatives, modifications, variations, improvements, and substantial equivalents that are or may be presently unforeseen may arise to applicants or others skilled in the art. Accordingly, the appended claims as filed and as they may be amended are intended to embrace all such alternatives, modifications variations, improvements, and substantial equivalents.

1. A device comprising:
a secure erase system;
a device UI;
a secure erase configuration UI; and
an element of the configuration UI selectable to indicate that the secure erase system should be used.

2. The device of claim 1 wherein the configuration UI further comprises an element selectable to indicate that a job should be secure erased upon its completion.

3. The device of claim 2 wherein the element indicates that every job should be secure erased upon its completion.

4. The device of claim 1 wherein the configuration UI further includes an element selectable to indicate that at least one NVM volume of the device should be erased using the secure erase system on a periodic basis.

5. The device of claim 4 wherein the configuration UI further comprises an element selectable to set up a secure erasure schedule for the at least one NVM volume of the device.

6. The device of claim 1 wherein the configuration UI is displayed on a UI of the device.

7. The device of claim 1 wherein the configuration UI is displayed on a personal computer connected to the device and employing driver software for the device.

8. A user-selectable secure erase method implemented on a marking device and comprising:
providing a secure erase indication UI element; and
providing at least one additional UI element to configure the secure erase method.

9. The method of claim 8 further comprising providing a UI element selectable to indicate that a job should be secure erased upon its completion.

10. The method of claim 9 further comprising indicating that every job should be secure erased upon its completion.

11. The method of claim 8 further comprising providing a UI element selectable to indicate that at least one NVM volume of the marking device should be erased using the secure erase system on a periodic basis.

12. The method of claim 11 further comprising providing a UI element selectable to set up a secure erasure schedule for the at least one NVM volume of the marking device.

13. The method of claim 8 further comprising displaying the elements on a UI of the marking device.

14. The method of claim 8 further comprising displaying the elements on a personal computer connected to the device and employing driver software for the device.

15. A device comprising a secure erase system, a device UI, a secure erase configuration UI, a first element of the configuration UI selectable to indicate that the secure erase system should be used, and a second element of the configuration selectable to indicate that a job should be secure erased upon its completion.

16. The device of claim 15 wherein the second element indicates that every job should be secure erased upon its completion.

17. The device of claim 15 wherein the configuration UI further includes a third element selectable to indicate that at least one NVM volume of the device should be erased using the secure erase system on a periodic basis.

18. The device of claim 17 wherein the configuration UI further comprises a fourth element selectable to set up a secure erasure schedule for the at least one NVM volume of the device.

19. The device of claim 15 wherein the configuration UI is displayed on a UI of the device.

20. The device of claim 15 wherein the configuration UI is displayed on a personal computer connected to the device and employing driver software for the device.

21. A user-selectable secure erase method implemented on a marking device and comprising providing a secure erase indication UI element and providing at least one additional UI element to configure the secure erase method, providing at least one additional UI element comprising providing a first UI element selectable to indicate that a job should be secure erased upon its completion.

22. The method of claim 21 wherein, when the first UI element is selected, the method further comprises indicating that every job should be secure erased upon its completion.

23. The method of claim 21 further comprising providing a UI element selectable to indicate that at least one NVM volume of the marking device should be erased using the secure erase system on a periodic basis.

24. The method of claim 23 further comprising providing a UI element selectable to set up a secure erasure schedule for the at least one NVM volume of the marking device.

25. The method of claim 21 further comprising displaying the elements on a UI of the marking device.

26. The method of claim 21 further comprising displaying the elements on a personal computer connected to the device and employing driver software for the device.
